(19) United States
(12) Patent Application Publication
(10) Pub. No.: US 2004/0261795 A1
(43) Pub. Date: Dec. 30, 2004

(54) Respirator mask and valve

(76) Inventor: Robert A. Brunell, Forestdale, MA (US)

Correspondence Address: Alexander J. Smolenski, Bromberg & Sunstein LLP, 125 Summer Street, Boston, MA, 02110-1618, US

(21) Appl. No.: 10/869,499

(22) Filed: Jun. 16, 2004

Related U.S. Application Data
(63) Continuation-in-part of application No. 10/229,935, filed on Aug. 28, 2002.
(60) Provisional application No. 60/479,116, filed on Jun. 17, 2003.

(51) Int. Cl. A62B 18/08; A62B 7/10

(52) U.S. Cl. 128/205.24; 128/207.13; 128/206.15

(57) ABSTRACT

A valve has a support member, a cover coupled with the support member, and a flexible member. The cover has a biasing member that secures the flexible member to the support member.

### CROSS REFERENCE TO RELATED APPLICATIONS

The present application claims priority from Provisional Application Ser. No. 60/479,116 entitled “Respirator Mask, Valve, and Method of Manufacture,” filed Jun. 17, 2003, which is incorporated herein by reference. The present application is also a continuation-in-part of U.S. patent application Ser. No. 10/229,935, entitled “Mask and Spherically Configured Valve,” filed Aug. 28, 2002, which is incorporated herein by reference.

### FIELD OF THE INVENTION

The invention generally relates to respirator masks and, more particularly, the invention relates to respirator masks and their associated valves.

### BACKGROUND OF THE INVENTION

Air filtration masks (referred to herein as “filter masks”) are widely used to protect people from air borne contaminants. For example, air borne dust particles are a commonly known hazard at a variety of different types of work sites. Consequently, workers at such sites often wear filter masks to avoid inhaling the potentially dangerous dust particles. To these ends, various types of filter masks are manufactured from a filtering material that filters contaminants from inhaled air. One problem with such filter masks, however, is that the filter material often creates an air resistance that can inhibit free breathing. To at least partially alleviate this problem, some filter masks include a one-way valve that permits its wearer to exhale more freely.

When the wearer is not exhaling, the valve should remain closed. In fact, this is preferred for all physical orientations of the mask. For example, if a flap valve is not normally biased closed by some force other than gravity, then it may open when the wearer bends over or otherwise causes the force of gravity to urge the flap away from its valve seat. Consequently, the filter mask may not provide the intended air filtering benefits.

The art has responded to this problem by providing filter masks with one-way valves that normally are biased closed in all physical orientations. The means for biasing the valve closed, however, varies from valve to valve. Some require extra parts, which increases the complexity and thus, the overall cost of the valve.

### SUMMARY OF THE INVENTION

In accordance with one aspect of the invention, a valve has a support member, a cover coupled with the support member, and a flexible member. The cover has a biasing member that secures the flexible member to the support member.

In related embodiments, the biasing member at least in part causes the flexible member to be normally spherically configured. In such cases, the flexible member may be normally flat when no forces are applied to it. The biasing member may have a living hinge that normally urges the flexible member into a spherical configuration. For example, the biasing member may have a living hinge having one end coupled with the cover. The living hinge also may have another end contacting the flexible member. The biasing member may provide a variable force against the flexible member.

In further related embodiments, the support member may include a valve seat, the flexible member being biased against the valve seat when in a closed mode to prevent fluid flow. The support member may include a member connector portion, wherein the biasing member causes the flexible member to be substantially flush with the member connector portion. The member connector portion may be spherically configured. The member connection portion may includes a registration post, wherein the biasing member includes a protrusion that is cup shaped so as to fit over the registration post when contacting the flexible member. The support member may include a valve seat having an effective center, the flexible member being biased against the valve seat when in a closed mode to prevent fluid flow, and wherein the biasing member secures the flexible member to the member connector portion at a position located between the valve seat and the effective center. The cover may include a guide pin, with the biasing mechanism including a guide recess for mating with the guide pin. The flexible member may be resilient.

In accordance with another aspect of the invention, a method of forming a valve provides a support member and a cover having a hinge, and positions a flexible member on the support member. The hinge is pivoted toward the cover interior to contact against the flexible member. The cover then may be secured to the support member.

In a related embodiment, the flexible member may include surfaces defining a registration hole, and the support member includes a member connector portion having a register post. Positioning the flexible member includes aligning the registration hole to the registration post.

In further related embodiments, the support member may include a valve seat, wherein positioning the flexible member includes positioning the flexible member on the valve seat. Contacting the hinge against the flexible member may include biasing the hinge against the flexible member. Biasing the hinge against the flexible member may include urging the flexible member into a spherical configuration.

In further related embodiments, the support member may include a member connector portion that is spherically configured, and biasing the hinge against the flexible member includes causing the flexible member to be substantially flush against the member connector portion. The hinge may be a living hinge. Contacting the hinge against the flexible member may include applying a variable force to the flexible member. Securing the cover to the front member may include at least one of snap-fitting or ultrasonic welding.

In accordance with another aspect of the invention, a valve has a support member, a cover coupled with the support member, and a flexible member. The cover has a variable force member that applies a variable force to the flexible member. The variable force member normally produces a concavity in the flexible member.

In accordance with yet another aspect of the invention, a valve has a support member, a cover coupled to the support member, and a flexible member. The cover has a biasing means for securing the flexible member to the support member.

In accordance with still another aspect of the invention, a filter mask has a valve. The valve includes a support member, a cover coupled with the support member, and a flexible member. The cover has a biasing member that secures the flexible member to the support member.

### BRIEF DESCRIPTION OF THE DRAWINGS

The foregoing and advantages of the invention will be appreciated more fully from the following further description thereof with reference to the accompanying drawings wherein:

FIG. 1 schematically shows a filter mask manufactured in accordance with illustrative embodiments of the invention.

FIG. 2A schematically shows an isometric view of a valve configured in accordance with illustrative embodiments of the invention, where the valve is in a closed mode.

FIG. 2B schematically shows an isometric view of the valve shown in FIG. 2A where the valve is in an open mode.

FIG. 3 schematically shows a plan view of a support member of the valve shown in FIGS. 2A and 2B.

FIG. 4 schematically shows a plan view of a cap of the valve shown in FIGS. 2A and 2B.

FIG. 5 schematically shows a cross-sectional view of the cap shown in FIG. 4 along line 5-5.

FIG. 6 schematically shows a cross-sectional view of the valve shown above in the closed mode.

FIG. 7 shows a process of assembling a valve in accordance with illustrative embodiments of the invention.

### DESCRIPTION OF ILLUSTRATIVE EMBODIMENTS

In illustrative embodiments, a valve has a variable force member that normally secures a flexible member against a valve seat to prevent fluid flow through the valve. Application of a sufficient force, however, opens the valve. The valve may be used in many applications, including in a filter mask. Details of illustrative embodiments are discussed below.

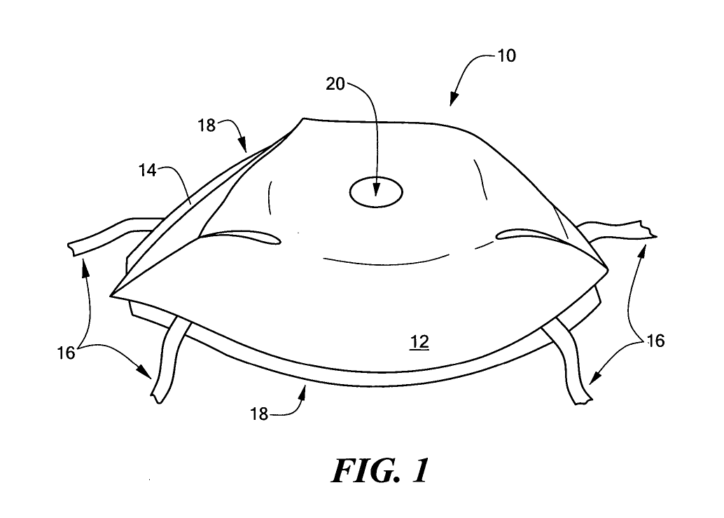

FIG. 1 schematically shows an exemplary filter mask 10 that may incorporate a valve constructed in accordance with illustrative embodiments of the invention. The mask 10 may be similar to those disclosed in the following co-pending, commonly owned U.S. patent applications: U.S. patent application Ser. No. 10/229,935, filed Aug. 28, 2002; and U.S. patent application Ser. No. 10/423,382, filed Apr. 25, 2003. The disclosures of both of those patent applications are incorporated herein, in their entireties, by reference. Of course, it should be noted that although the mask 10 shown in those patent applications and FIG. 1 are discussed, differently configured filter masks may be used in various embodiments of the invention.

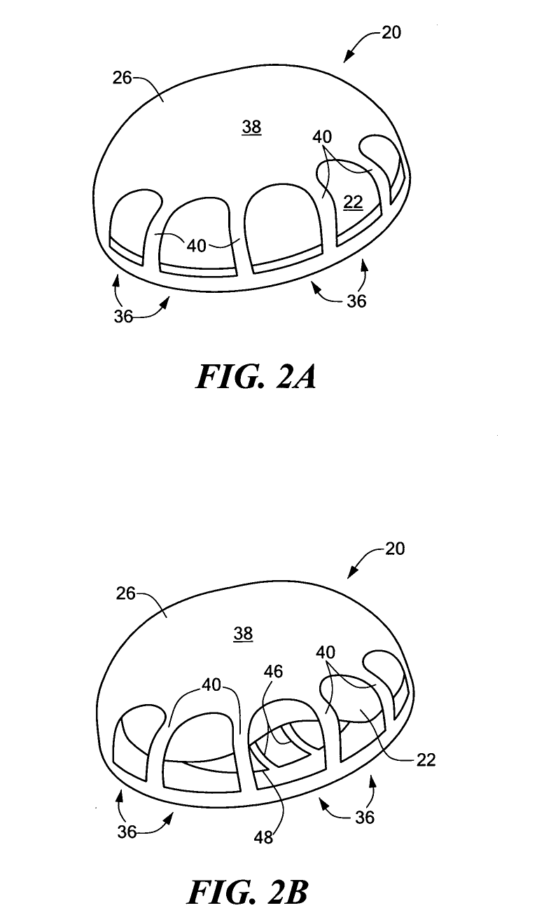

The filter mask 10 includes a filter layer 12 that is supported on a porous, but relatively more rigid, molded support base 14. In illustrative embodiments, the filter layer 12 and support base 14 are sufficiently resilient so that the filter mask 10 has a normally open concave area for sealingly receiving a user's nose and mouth. The filter mask 10 also includes a nose piece (not shown) to properly position the mask 10 against the user's nose, straps 16 to secure the mask 10 to the user's face, and a peripheral rim 18 that contours to the user's face when worn. The filter mask 10 also includes the above noted one-way valve 20, which more freely permits air to be exhaled. Details of the valve 20 are discussed below with reference to FIGS. 2A-6.

The straps 16 may be constructed from a resilient rubber material, or other conventionally known material (e.g., a non-resilient fabric), that permits a secure and snug fit between the user's face and the rim 18. The straps 16 thus apply an inwardly directed force for those purposes. At a minimum, this force should be sufficient at least to hold the mask 10 to the user's face. Moreover, it is preferred that the rim 18 have a contoured surface that contours to the user's face. Accordingly, when the straps 16 apply the noted inwardly directed force to the mask 10, the contoured surface should be sufficiently flexible and resilient to shape to the user's face. This ensures that the substantial majority of the user's air is inhaled and exhaled through the filter mask 10. In some embodiments, the rim 18 includes additional material (e.g., rubber) to provide an effective seal against the user's face.

FIG. 2A-6 show details of illustrative embodiments of the valve 20. In particular, with reference to FIGS. 2A and 2B, the valve 20 includes a rigid plastic housing containing a flexible member, referred to herein as “flap 22.” Those skilled in the art sometimes refer to the flap 22 as a “diaphragm.” The interior of the housing is manufactured so that when the valve 20 is in a closed mode (i.e., FIG. 2A), the flap 22 is positioned to prevent air flow through the valve 20. Conversely, when the valve 20 is in an open mode (i.e., FIG. 2B), the flap 22 is positioned to permit air flow through the valve 20 in one direction. Consequently, movement of the flap 22 causes the valve 20 to transition between open and closed modes.

In illustrative embodiments, the housing is made up of two pieces that are attached together. Specifically, those two pieces are: a support member 24 for connecting to the flap 22, as shown in FIG. 2A; and a cover 26 for covering the flap 22, as shown in FIG. 2B.

The cover 26 has an open portion 36 to freely permit airflow, and a covered portion 38. The open portion 36 includes a plurality of fingers 40 that extend from the covered portion 38 to the periphery of the cover 26. The covered portion 38 may include a logo or other indicia indicating the make or type of mask 10. In alternative embodiments, the cover 26 does not include the covered portion 38. Specifically, in such embodiments, the substantial majority of the cover 26 may be open to freely permit fluid flow.

The flap 22 may be produced from a flexible and resilient material that normally is substantially flat. In various embodiments, the material is a rubber, such as conventional gum rubber. More specifically, in illustrative embodiments, conventional processes stamp the flap 22 from a sheet of gum rubber to be in a substantially circular shape. No specialized molding processes are necessary to control the degree of curvature of the flap 22. It should be noted that although a specific material has been discussed (i.e., gum rubber), its discussion is exemplary and not intended to limit the scope of the invention.

Accordingly, in a manner similar to the discussed sheet of gum rubber, the flap 22 normally is substantially flat when not coupled with the valve 20. Details of the process of securing the flap 22 to the support member 24 are discussed below.

The support member 24 is specifically manufactured to cause the flap 22 to be spherically configured when the valve 20 is in its closed mode. More particularly, the flap 22 is considered to be “spherically configured” when its surface has a radius of curvature that is substantially uniform in all directions. In other words, to be spherically configured, all points on the surface of the flap 22 have a substantially identical (but finite—i.e., not flat) radius of curvature. More generally, an element of the valve 20 is considered to be spherically configured when such element has a radius of curvature that is substantially uniform. The flap 22 thus may be considered to be normally spherically configured when within the valve 20.

To these ends, the support member 24 includes a spherically configured flap connector portion 44 for connecting with the flap 22, while the cover 26 has an integral hinged arm 46 (discussed in greater detail below) for forcing the flap 22 to be substantially flush with the flap connector portion 44 (i.e., securing the flap 22 to the support member 24). The flap connector portion 44 has a relatively large radius of curvature that also causes the ultimate radius of curvature of the flap 22 to be relatively large. In addition, the support member 24 also includes a valve seat 48 that cooperates with the flap 22 to seal the valve 20. The valve seat 48, which may also be spherically configured, illustratively is in a single plane that is different than that of the flap connector portion 44. Positioning the valve seat 48 in a different plane than that of the flap connector portion 44 more effectively permits the flap 22 to be spherically configured.

As noted above, to secure the flap 22, the cover 26 has a hinged arm 46 that clamps down over the flap 22. The arm 46 is configured to provide a variable and inwardly directed force that normally forces the flap 22 to be substantially flush against the flap connector portion 44. Specifically, when the flap 22 is forced inwardly, its outer periphery bears against the valve seat 48, while a portion of its surface is substantially flush against the connector portion 44. This combination of forces causes the flap 22 to be concave in a spherical configuration. Because it is spherically configured, the resiliency of the flap 22 advantageously biases the flap 22 to remain closed in all orientations when the mask user is not exhaling.

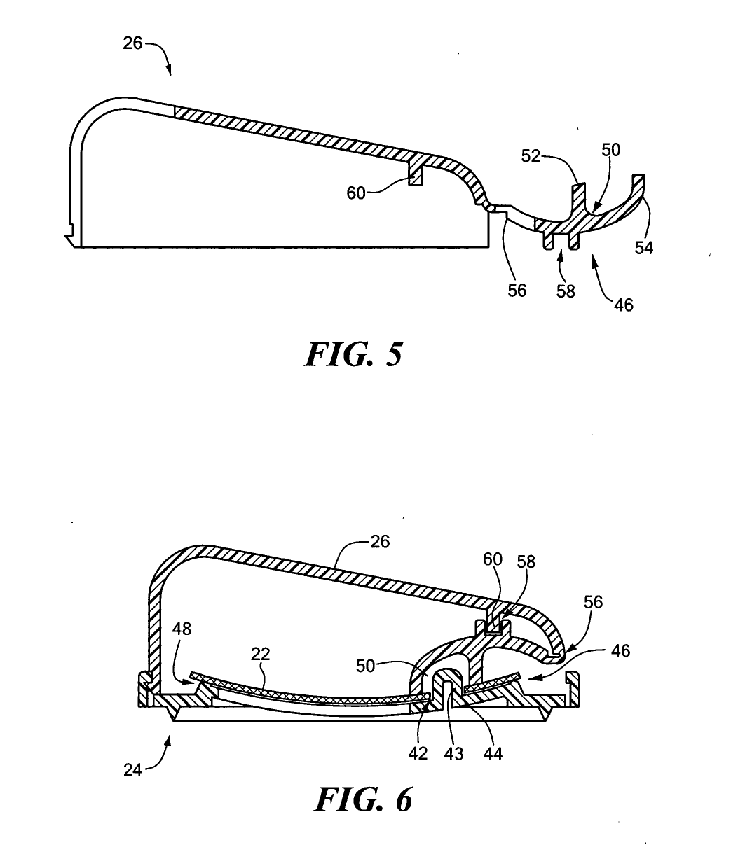

As shown in FIGS. 4 and 5, the hinged arm 46 has a cupped portion 50 formed by first and second edges 52 and 54 at one end, and a pivot point 56 secured to the remainder of the cover 26. In various embodiments, the pivot point 56 effectively forms, without limitation, a “living hinge” as known by those skilled in the art. In the present specification and the appended claims, the term “living hinge” shall refer to a single piece of material having two segments that rotate with respect to each other substantially about a fixed point through deformation of the material. A living hinge may also be described as an “integral hinge.”

The cover 26 (and its integral hinged arm 46) preferably is produced by conventional injection molding processes. Materials used to make the cover 26 can include plastics, polymers, elastomers, and/or other materials.

The cover 26 illustratively is formed so that when first removed from a molding machine, the hinged arm 46 normally extends somewhat radially outwardly as shown in FIGS. 4 and 5. Accordingly, when the valve 20 is assembled, the hinged arm 46 is rotated about its pivot point 56 toward the center of the cover 26.

More specifically, FIG. 6 schematically shows a cross-sectional view of the fully assembled valve 20 in a closed mode. As shown, the cupped portion 50 of the hinged arm 46 fits over two registration posts 43 to frictionally secure the flap 22 within the valve 20. In particular, the first and second edges 52 and 54 effectively lock the flap 22 against the flap connector portion 44. This frictional fit secures the flap 22 within the valve 20.

In various embodiments, the hinged arm 46 secures the flap 22 to the flap connector portion 44 at a location that is off center relative to the entire valve 20. Specifically, the flap 22 is not secured to the flap connector portion 44 at the valves center, or at the valve's periphery. While still enabling some relative flap stiffness, this arrangement permits the cracking pressure (i.e., the minimum air pressure to open the valve 20) to be lower than if the same flap 22 were connected at the substantial center of the valve 20. In addition, in a manner different than if it were connected at its periphery, this arrangement also permits the entire 360 degrees of the flap 22 to lift from the valve seat 48 to permit air flow. It should be noted that principles of the noted off-center connection applies to other valves that are not necessarily circular. For example, for a valve that is not symmetrically shaped with an exact center, a connection spaced away from an effective center should provide similar results.

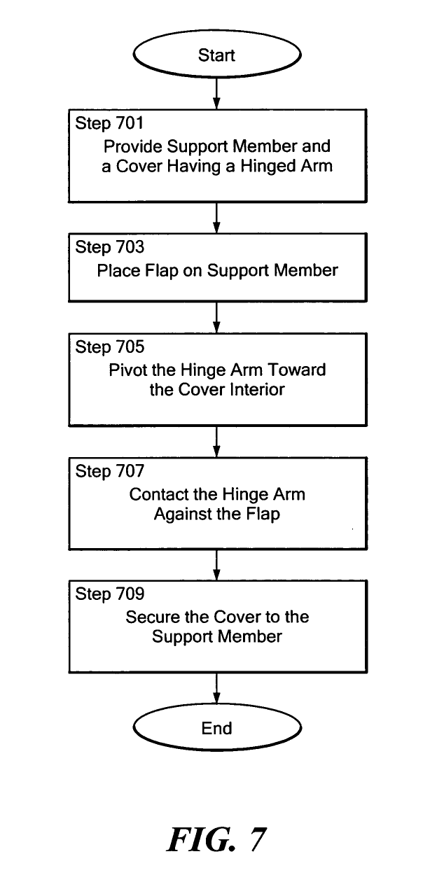

FIG. 7 shows a process of assembling a valve, in accordance with illustrative embodiments of the invention. The process begins at step 701, in which the support member 24 and the cover 26 having a hinged arm 46 are provided.

The process continues to step 703, in which the flap 22 is placed on the support member 24 in step 703. In various embodiments, the flap 22 includes holes 42 for aligning with registration posts 43 on the support member 24, as shown in FIG. 6. This ensures, among other things, proper alignment of the flap 22 on the support member's valve seat 48.

The hinged arm 46 is pivoted, in step 705 of the process, about its pivot point 56 to the position shown in FIG. 6. As discussed above, the hinged arm 46 may be a living hinge that initially extends outward from the cover 26, and must be rotated towards the interior of the cover 26.

The hinged arm is then brought in contact against the flap 22. As suggested above, the hinged arm 46 is considered to provide a variable force to the flap 22. In contrast to a solid member extending downwardly from the top of the cover 26 interior, the hinged arm 46 is resilient and has some flexibility, thus providing a variable force to the flap 22.

The flexibility of the hinged arm 46 advantageously allows for variance in support member 24 and cover 26 manufacturing dimensions. For example, if the connector portion 44 is manufactured slightly out of tolerance, such as by being slightly raised, the position of the hinged arm 46 is capable of pivoting to the appropriate contact position.

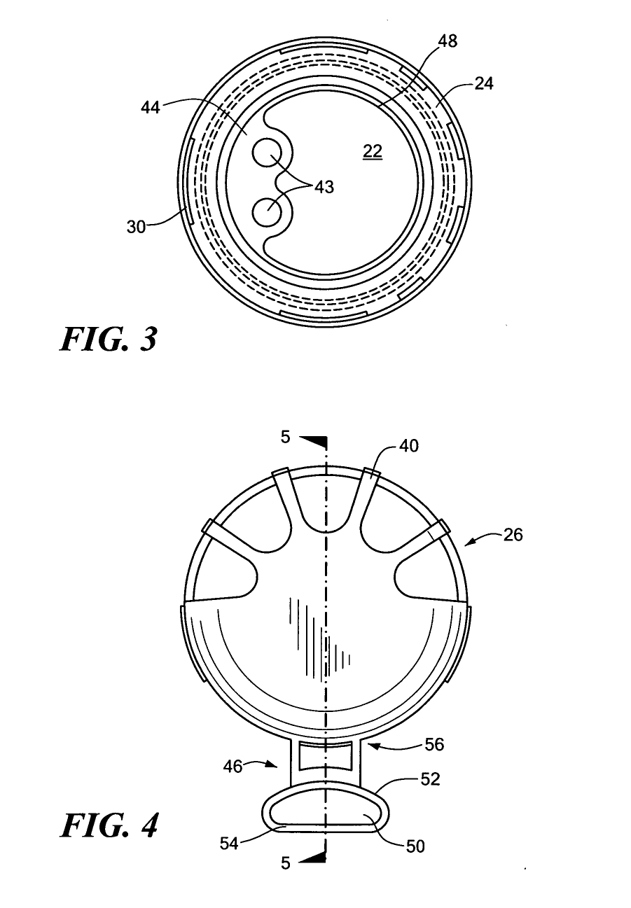

The cover 26 is then secured to the support member 24 in step 709 of the process. The cover 26 and support member 24 may be connected in any manner known in the art, such as with a snap-fit or ultrasonic welding. In illustrative embodiments, the cover 26 includes a tooth (not shown) that mates with a corresponding slot 30 in the support member 24 (see FIG. 3) to align the two housing portions 24 and 26. Additionally, the cover 26 may have a small protruding flange (not shown) around its periphery to snap into flexible mating ridges (not shown) on the support member 24. In various embodiments, the hinged arm 46 may also have a guide recess 58 that, when the cover 26 is attached to the support member 24, mates in registry with a guide pin 60 extending downwardly from the cover 26, as shown in FIG. 6.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A valve comprising:
a support member;
a cover coupled with the support member; and
a flexible member,
the cover having a biasing member that secures the flexible member to the support member.

2. The valve as defined by claim 1 wherein the biasing member at least in part causes the flexible member to be normally spherically configured.

3. The valve as defined by claim 2 wherein the flexible member is normally flat when no forces are applied to it.

4. The valve as defined by claim 1, wherein the support member includes a valve seat, the flexible member being biased against the valve seat when in a closed mode to prevent fluid flow.

5. The valve as defined by claim 1, wherein the biasing member includes a living hinge that normally urges the flexible member into a spherical configuration.

6. The valve as defined by claim 5, wherein the living hinge has a first end coupled with the cover, the living hinge also having a second end extending toward and contacting the flexible member.

7. The valve as defined by claim 1, wherein the biasing member provides a variable force against the flexible member.

8. The valve as defined by claim 1, wherein the support member includes a member connector portion, and wherein the biasing member causes the flexible member to be substantially flush with the member connector portion.

9. The valve as defined by claim 8, wherein the member connector portion is spherically configured.

10. The valve as defined by claim 8, wherein the member connection portion includes a registration post, and wherein the biasing member includes a protrusion that is cup shaped so as to fit over the registration post when contacting the flexible member.

11. The valve as defined by claim 8, wherein the support member includes a valve seat having an effective center, the flexible member being biased against the valve seat when in a closed mode to prevent fluid flow, and wherein the biasing member secures the flexible member to the member connector portion at a position located between the valve seat and the effective center.

12. The valve as defined by claim 1, wherein the cover includes a guide pin, and the biasing mechanism includes a guide recess for mating with the guide pin.

13. The valve as defined by claim 1, wherein the flexible member is resilient.

14. A method of forming a valve comprising:
providing a support member and a cover having a hinge;
positioning a flexible member on the support member;
pivoting the hinge toward the cover interior;
contacting the hinge against the flexible member; and
securing the cover to the support member.

15. The method as defined by claim 14, wherein the flexible member includes surfaces defining a registration hole, and the support member includes a member connector portion having a register post, and wherein positioning the flexible member includes aligning the registration hole to the registration post.

16. The method as define by claim 14, wherein the support member includes a valve seat, and wherein positioning the flexible member includes positioning the flexible member on the valve seat.

17. The method as defined by claim 14, wherein contacting the hinge against the flexible member includes biasing the hinge against the flexible member.

18. The method as defined by claim 17, wherein biasing the hinge against the flexible member includes urging the flexible member into a spherical configuration.

19. The method as defined by claim 17, wherein the support member includes a member connector portion that is spherically configured, and wherein biasing the hinge against the flexible member includes causing the flexible member to be substantially flush against the member connector portion.

20. The method as defined by claim 17, wherein the hinge is a living hinge.

21. The method according to claim 14, wherein contacting the hinge against the flexible member includes applying a variable force to the flexible member.

22. The method according to claim 14, wherein securing the cover to the front member includes at least one of snap-fitting or ultrasonic welding.

23. A product formed by the process of claim 14.

24. A valve comprising:
a support member;
a cover coupled with the support member; and
a flexible member,
the cover having a variable force member that applies a variable force to the flexible member, the variable force member normally producing a concavity in the flexible member.

25. The valve as defined by claim 24, wherein the flexible member is normally flat when no forces are applied to it.

26. The valve as defined by claim 24, wherein the support member includes a valve seat, the flexible member being biased against the valve seat when in a closed mode to prevent fluid flow.

27. The valve as defined by claim 24, wherein the variable force member includes a living hinge.

28. The valve as defined by claim 27, wherein the living hinge has a first end coupled with the cover, the living hinge also having a second end with a protrusion extending toward and contacting the flexible member.

29. The valve as defined by claim 28, wherein the support member includes a member connector portion, and wherein the protrusion causes the flexible member to be substantially flush with the member connector portion.

30. The valve as defined by claim 29, wherein the member connector portion is spherically configured.

31. A valve comprising:
a support member;
a cover coupled to the support member; and
a flexible member,
the cover having a biasing means for securing the flexible member to the support member.

32. The valve as defined by claim 31, wherein the flexible member is normally flat when no forces are applied to it.

33. The valve as defined by claim 31, wherein the flexible member is made of, at least in part, a rubber.

34. The valve as defined by claim 31, wherein the support member includes a valve seat, the flexible member being biased against the valve seat when in a closed mode to prevent fluid flow.

35. The valve as defined by claim 31, wherein the biasing means is a living hinge that normally urges the flexible member into a spherical configuration.

36. The valve as defined by claim 31, wherein the biasing means provides a variable force against the flexible member.

37. The valve as defined by claim 31, wherein the support member includes a member connector portion, and wherein the biasing means causes the flexible member to be substantially flush with the member connector portion.

38. The valve as defined by claim 37, wherein the member connector portion is spherically configured.

39. The valve as defined by claim 31, wherein the flexible member is resilient.

40. A filter mask having a valve, the valve comprising:
a support member; and
a cover coupled with the support member; and
a flexible member,
the cover having a biasing member that secures the flexible member to the support member.

41. The valve as defined by claim 40, wherein the support member includes a valve seat, the flexible member being biased against the valve seat when in a closed mode to prevent fluid flow.

42. The valve as defined by claim 40, wherein the biasing member is a living hinge that normally urges the flexible member into a spherical configuration.

43. The valve as defined by claim 40, wherein the biasing member provides a variable force against the flexible member.

44. The valve as defined by claim 40, wherein the support member includes a member connector portion, and wherein the biasing means causes the flexible member to be substantially flush with the member connector portion.

45. The valve as defined by claim 44, wherein the member connector portion is spherically configured.

46. The valve as defined by claim 40, wherein the flexible member is resilient.
